(19) United States
(12) Patent Application Publication
(10) Pub. No.: US 2017/0238351 A1
(43) Pub. Date: Aug. 17, 2017

(54) MUTUALLY CONNECTING WIRELESS EQUIPMENT AND COMMUNICATION SYSTEM

(71) Applicant: JVC KENWOOD Corporation, Yokohama-shi (JP)

(72) Inventor: Tomohiro AZAMI, Yokohama-shi (JP)

(73) Assignee: JVC KENWOOD Corporation, Yokohama-shi (JP)

(21) Appl. No.: 15/422,073

(22) Filed: Feb. 1, 2017

(30) Foreign Application Priority Data
Feb. 12, 2016 (JP) 2016-024563

(51) Int. Cl. H04W 76/02; H04W 4/00; H04W 8/00

(52) U.S. Cl. CPC H04W 76/023; H04W 8/005; H04W 76/027; H04W 4/008

(57) ABSTRACT

A reception unit receives a connection request from each of a plurality of pieces of request-side wireless apparatus. A reception unit also receives found information that is from each of a plurality of pieces of request-side wireless apparatus and that regards one or more pieces of admission-side wireless apparatus that have been found via search by request-side wireless apparatus. An admitter admits connection for one of a plurality of pieces of request-side wireless apparatus with respect to a connection request received at a reception unit. At that time, an admitter performs selection based on found information received at a reception unit.

### CROSS REFERENCE TO RELATED APPLICATION

This application is based upon and claims the benefit of priority from the prior Japanese Patent Application No. 2016-024563, filed on Feb. 12, 2016, the entire contents of which are incorporated herein by reference.

### BACKGROUND

1. Field

The present invention relates to a communication technology, in particular, mutually connecting wireless apparatus and a communication system.

2. Description of the Related Art

In the conventional practice, there is a case where near-field communication is used in order to connect wireless apparatus. In near-field communication, there is a case where one piece of wireless apparatus can be connected to a plurality of other pieces of wireless apparatus. In order to improve convenience of connection configuration, automatic connection is performed in descending order of priority given to other wireless apparatus (refer to JP 2012-147145 A for example).
Patent Literature 1: JP 2012-147145 A

Since the distance of communication enabled via near-field communication is approximately a few meters, in a case where there are a plurality of pieces of wireless apparatus, depending on an arrangement thereof, a combination of the wireless apparatus capable of performing communication is formed, and the wireless apparatus incapable of performing communication also exists. For effective use of wireless apparatus, it is preferable to minimize the number of pieces of wireless apparatus incapable of performing communication.

### SUMMARY

To solve the above problem, wireless apparatus of a mode of the present embodiment is wireless apparatus on a side where connection is requested, the wireless apparatus including a searcher that searches other wireless apparatus on a side where connection is admitted, a storage unit that stores found information regarding one or more pieces of other wireless apparatus that have been found as a result of search at the searcher, and a requester that requests connection on one piece of other wireless apparatus in found information stored in the storage unit. The requester also transmits found information stored in the storage unit to one piece of other wireless apparatus.

Another mode of the present embodiment is also wireless apparatus. This apparatus is wireless apparatus on a side where connection is admitted, the wireless apparatus including a reception unit that receives a connection request from each of a plurality of pieces of other wireless apparatus on a side where connection is requested and an admitter that admits connection for one of a plurality of other wireless apparatus on a side where connection is requested with respect to a connection request received at the reception unit. The reception unit also receives found information that is from each of a plurality of pieces of other wireless apparatus on a side where connection is requested and that regards one or more pieces of wireless apparatus on a side where connection is admitted that have been found via search by other wireless apparatus on a side where connection is requested, and the admitter performs selection based on found information received at the reception unit.

Yet another mode of the present embodiment is a communication system. This communication system includes one or more pieces of request-side wireless apparatus on a side where connection is requested and one or more pieces of admission-side wireless apparatus on a side where connection is admitted. Each of the one or more pieces of request-side wireless apparatus includes a searcher that searches the one or more pieces of admission-side wireless apparatus, a storage unit that stores found information regarding one or more pieces of admission-side wireless apparatus that have been found as a result of search at the searcher, and a requester that requests connection for one piece of admission-side wireless apparatus in found information stored in the storage unit and also transmits found information stored in the storage unit to the one piece of admission-side wireless apparatus. Each of the one or more pieces of admission-side wireless apparatus includes a reception unit that receives a connection request from request-side wireless apparatus and also receives found information and an admitter that admits connection for one piece of request-side wireless apparatus based on found information received at the reception unit with respect to a connection request received at the reception unit.

It is to be noted that arbitrary combinations of the above components and the description of the present embodiment that is converted among a method, apparatus, system, medium, computer program, and the like are also effective as a mode of the present embodiment.

### BRIEF DESCRIPTION OF THE DRAWINGS

FIG. 1 is a diagram that presents a configuration of a communication system according to an embodiment;

FIG. 2 is a diagram that presents a configuration of request-side wireless apparatus of FIG. 1;

FIGS. 3A and 3B are diagrams that present information included in a signal transmitted from the request-side wireless apparatus of FIG. 2;

FIG. 4 is a diagram that presents a configuration of admission-side wireless apparatus of FIG. 1;

FIGS. 5A and 5B are sequence diagrams that present a connection procedure by the communication system of FIG. 1; and

FIG. 6 is a flowchart that presents a connection procedure by the admission-side wireless apparatus of FIG. 4.

### DETAILED DESCRIPTION

The invention will now be described by reference to the preferred embodiments. This does not intend to limit the scope of the present invention, but to exemplify the invention.

The present invention will be outlined before explained in detail. The embodiment relates to a communication system that includes wireless apparatus that is connected via near-field communication. Here, wireless apparatus is classified into wireless apparatus such as a smart watch (hereinafter called “request-side wireless apparatus”) on a side where connection is requested and wireless apparatus such as a smart phone (hereinafter called “admission-side wireless apparatus”) on a side where connection is admitted. The communication system includes a plurality of pieces of request-side wireless apparatus and includes a plurality of pieces of admission-side wireless apparatus. Here, a situation is assumed in which two or more pieces of request-side wireless apparatus cannot be concurrently connected to one piece of admission-side wireless apparatus.

Under such a situation, the request-side wireless apparatus cannot derive information from outside unless connected to the admission-side wireless apparatus, and hence it is desirable to form as many combinations of pieces of connecting request-side wireless apparatus and admission-side wireless apparatus as possible. In the present embodiment, the following processing is performed so as to efficiently connect request-side wireless apparatus with admission-side wireless apparatus. The request-side wireless apparatus searches admission-side wireless apparatus that exists in a connectable distance and thus constructs information (hereinafter called “found information”) regarding one or more pieces of admission-side wireless apparatus that have been found. The request-side wireless apparatus selects one piece of admission-side wireless apparatus, requests connection on the piece of admission-side wireless apparatus, and at that time transmits found information.

The admission-side wireless apparatus is requested for connection from new request-side wireless apparatus in a situation where request-side wireless apparatus has already been connected thereto (this request-side wireless apparatus will hereinafter be called “connected request-side wireless apparatus”). At that time, the admission-side wireless apparatus confirms found information from the new request-side wireless apparatus and also confirms found information from the connected request-side wireless apparatus. Here, only one piece of admission-side wireless apparatus is shown in the found information from the new request-side wireless apparatus, and when two or more pieces of admission-side wireless apparatus are shown in the found information from the connected request-side wireless apparatus, the admission-side wireless apparatus disconnects the connected request-side wireless apparatus. In addition, the admission-side wireless apparatus admits connection of the new request-side wireless apparatus. On the other hand, the admission-side wireless apparatus rejects connection of the new request-side wireless apparatus when found information from the new request-side wireless apparatus and the connected request-side wireless apparatus is in a combination other than those described above.

In other words, basically, while maintaining connection with the connected request-side wireless apparatus, the admission-side wireless apparatus admits a preferential connection with request-side wireless apparatus that has not found other admission-side wireless apparatus. It is to be noted that the disconnected connected request-side wireless apparatus requests connection on other admission-side wireless apparatus included in found information.

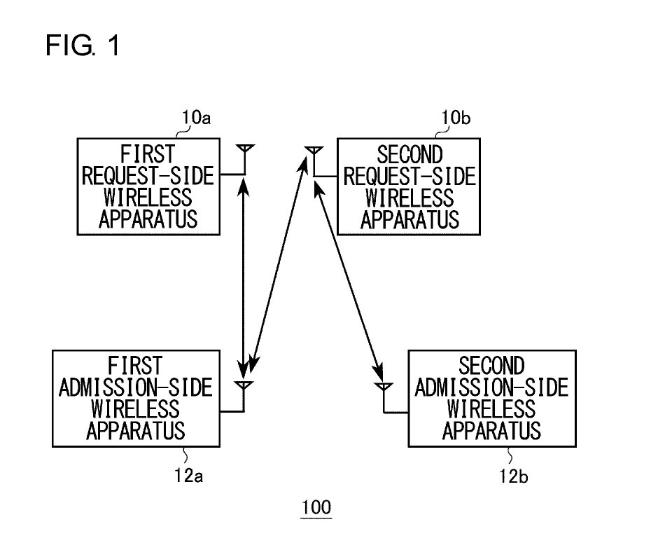

FIG. 1 is a diagram that presents a configuration of a communication system 100 according to an embodiment. The communication system 100 includes a first request-side wireless apparatus 10a and a second piece of request-side wireless apparatus 10b that are collectively called request-side wireless apparatus 10 and a first admission-side wireless apparatus 12a and a second piece of admission-side wireless apparatus 12b that are collectively called admission-side wireless apparatus 12. Although two pieces of request-side wireless apparatus 10 and two pieces of admission-side wireless apparatus 12 are presented here, the numbers of pieces of the request-side wireless apparatus 10 and the admission-side wireless apparatus 12 are not limited thereto.

The request-side wireless apparatus 10 is wireless apparatus on a side where connection is requested in near-field communication. Here, the near-field communication is Bluetooth (registered trade mark). As mentioned earlier, one example of the request-side wireless apparatus 10 is a smart watch that derives information from the admission-side wireless apparatus 12 described later via near-field communication.

The admission-side wireless apparatus 12 is wireless apparatus on a side where connection is admitted in near-field communication. As mentioned earlier, one example of the admission-side wireless apparatus 12 is a smart phone that has a communication function of mobile telephone communication W-MAN (Wireless-Metropolitan Area Network) (hereinafter called “long-distance wireless communication”) that is not shown, in addition to the near-field communication. Thus, the admission-side wireless apparatus 12 transfers information derived via long-distance wireless communication to the request-side wireless apparatus 10 via near-field communication. As a result, a variety of notices on a smart phone are displayed on a smart watch and a smart phone is controlled by operating a smart watch.

Since the distance of communication enabled via near-field communication is approximately a few meters, a combination of the request-side wireless apparatus 10 with the admission-side wireless apparatus 12 capable of communicating is affected by an arrangement of the request-side wireless apparatus 10 and the admission-side wireless apparatus 12. In FIG. 1, while the first request-side wireless apparatus 10a is capable of performing communication only with the first admission-side wireless apparatus 12a, the second piece of request-side wireless apparatus 10b is capable of performing communication with the first admission-side wireless apparatus 12a and the second piece of admission-side wireless apparatus 12b. It is to be noted that whether or not to be capable of performing communication may be determined by a factor other than the distance. For instance, it is determined by a case where the request-side wireless apparatus 10 is capable of performing communication only with the admission-side wireless apparatus 12 that has been added by the user in advance. This corresponds to that in FIG. 1 only the first admission-side wireless apparatus 12a is added with the first request-side wireless apparatus 10a and the first admission-side wireless apparatus 12a and the second piece of admission-side wireless apparatus 12b are added with the second piece of request-side wireless apparatus 10b.

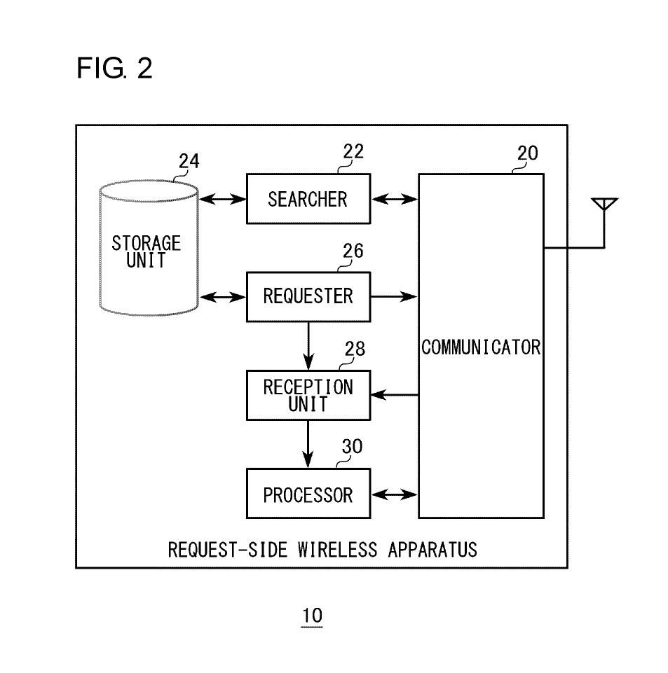

FIG. 2 is a diagram that presents a configuration of the request-side wireless apparatus 10. The request-side wireless apparatus 10 includes a communicator 20, a searcher 22, a storage unit 24, a requester 26, a reception unit 28, and a processor 30. The communicator 20 performs communication via near-field communication. Since a publicly known technology may be used for near-field communication, its explanation is omitted now.

The searcher 22 searches the admission-side wireless apparatus 12 via the communicator 20. More specifically, the communicator 20 receives a signal transmitted from the admission-side wireless apparatus 12. The communicator 20 outputs a received signal to the searcher 22. The searcher 22 extracts identification information that is included in a signal having been input from the communicator 20 and that is given to the admission-side wireless apparatus 12. If the extracted identification information is one that has been added in advance, communication with the admission-side wireless apparatus 12, which is the source, is possible, and hence the searcher 22 outputs the extracted identification information to the storage unit 24. This corresponds to that the admission-side wireless apparatus 12 capable of performing communication is found. The searcher 22 repeatedly performs this processing.

Identification information from the searcher 22 is input to the storage unit 24 and the storage unit 24 stores the pieces of identification information together. The stored information is the found information mentioned earlier and the found information includes information regarding one or more pieces of admission-side wireless apparatus 12 that have been found. For example, in the configuration of FIG. 1, the found information stored in the storage unit 24 of the first request-side wireless apparatus 10a includes information only regarding the first admission-side wireless apparatus 12a. The found information stored in the storage unit 24 of the second piece of request-side wireless apparatus 10b includes information regarding the first admission-side wireless apparatus 12a and the second piece of admission-side wireless apparatus 12b.

The requester 26 selects one piece of admission-side wireless apparatus 12 in the found information stored in the storage unit 24. For instance, the requester 26 selects the admission-side wireless apparatus 12 that has the greatest signal strength of a received signal, in other words, the admission-side wireless apparatus 12 that is estimated to exist closest to the present request-side wireless apparatus 10. The requester 26 transmits a connection request to the selected admission-side wireless apparatus 12 via the communicator 20. In the configuration of FIG. 1, for example, the second piece of request-side wireless apparatus 10b transmits a connection request to the first admission-side wireless apparatus 12a of the first admission-side wireless apparatus 12a and the second piece of admission-side wireless apparatus 12b. On the other hand, the first request-side wireless apparatus 10a transmits a connection request to the first admission-side wireless apparatus 12a.

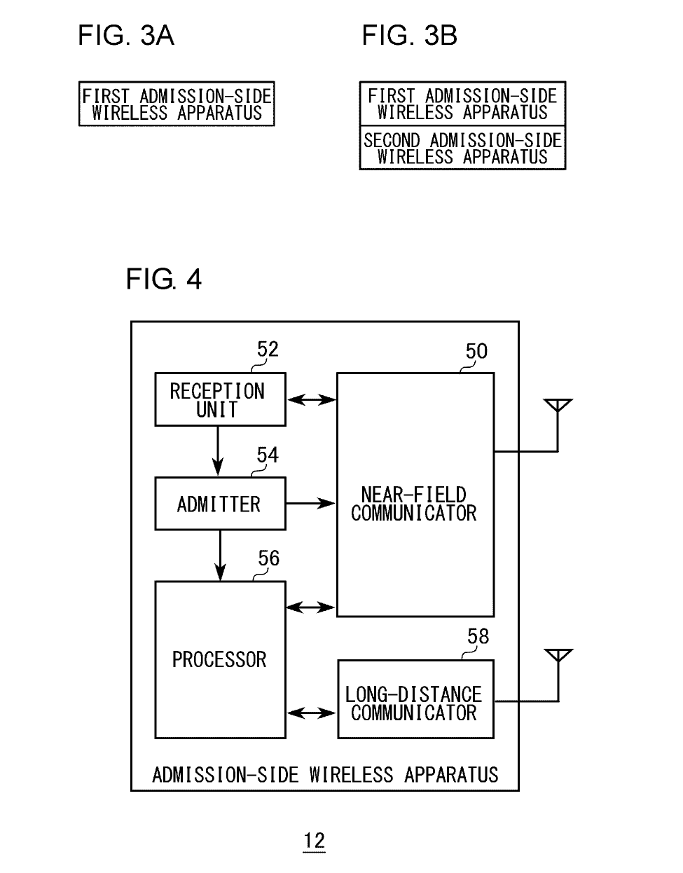

After temporary connection with the admission-side wireless apparatus 12 is established by transmission of a connection request, the requester 26 receives a request for found information from the admission-side wireless apparatus 12 via the communicator 20. Upon receiving the request for found information, the requester 26 transmits the found information stored in the storage unit 24 to the admission-side wireless apparatus 12 via the communicator 20. FIGS. 3A and 3B present information included in a signal transmitted from the request-side wireless apparatus 10. FIG. 3A presents a configuration of found information from the first request-side wireless apparatus 10a that includes information regarding “the first admission-side wireless apparatus 12a” as an example. FIG. 3B presents found information from the second piece of request-side wireless apparatus 10b, the found information including information regarding “the first admission-side wireless apparatus 12a” and information regarding “the second piece of admission-side wireless apparatus 12b” as an example. The description returns to FIG. 2.

After transmitting found information, the reception unit 28 receives a response to the connection request from the admission-side wireless apparatus 12 via the communicator 20. The response includes admission of connection or rejection of connection. In case where admission of connection is included, the processor 30 performs communication with the admission-side wireless apparatus 12 via the communicator 20. In a case where rejection of connection is included, on the other hand, the requester 26 selects another one piece of admission-side wireless apparatus 12 in the found information stored in the storage unit 24. The requester 26 transmits a connection request to the selected another one piece of admission-side wireless apparatus 12 via the communicator 20 in a similar manner to the previous manner. In addition, the requester 26 constructs new found information in which information regarding the one piece of admission-side wireless apparatus 12 with which connection has been rejected at the reception unit 28 is removed from the found information stored in the storage unit 24. After the temporary connection, the requester 26 transmits the new found information to the selected another one piece of admission-side wireless apparatus 12 via the communicator 20.

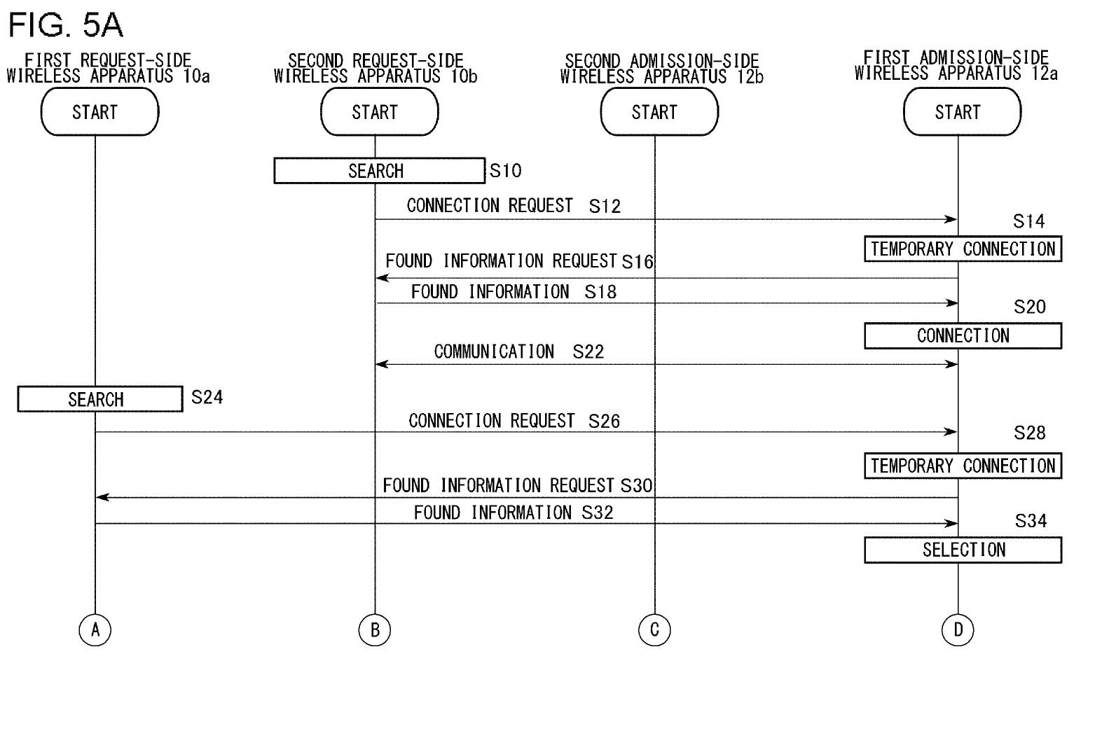

FIG. 4 presents a configuration of the admission-side wireless apparatus 12. The admission-side wireless apparatus 12 includes a near-field communicator 50, a reception unit 52, an admitter 54, a processor 56, and a long-distance communicator 58. The long-distance communicator 58 performs communication via long-distance communication. Since a publicly known technology may be used for long-distance communication, its explanation is omitted now. Similar to the communicator 20, the near-field communicator 50 performs communication via near-field communication. Since a publicly known technology may be used for near-field communication, its explanation is omitted now.

The reception unit 52 receives a connection request from each of the plurality of pieces of request-side wireless apparatus 10 via the near-field communicator 50. If receiving a connection request, the reception unit 52 performs temporary connection with the request-side wireless apparatus 10 with respect to the near-field communicator 50. After the temporary connection, the reception unit 52 transmits a request for found information to each of the plurality of pieces of request-side wireless apparatus 10 via the near-field communicator 50. After transmitting the request for found information, the reception unit 52 receives found information from each of the plurality of pieces of request-side wireless apparatus 10 via the near-field communicator 50. As mentioned earlier, the found information includes information regarding one or more pieces of admission-side wireless apparatus 12 that have been found via search by the request-side wireless apparatus 10. The reception unit 52 outputs the connection request and the found information to the admitter 54.

The connection request and the found information are input to the admitter 54 from the reception unit 52. The admitter 54 extracts identification information that is included in a connection request and that is to identify the request-side wireless apparatus 10 that is the source of the connection request. If the extracted identification information is one that has been added in advance, the admitter 54 admits connection of the request-side wireless apparatus 10 unless another one piece of request-side wireless apparatus 10 has already been connected. At that time, the admitter 54 stores the found information. The admitter 54 transmits a response that includes admission of connection to the request-side wireless apparatus 10 via the near-field communicator 50.

In a case where another one piece of request-side wireless apparatus 10 has already been connected, on the other hand, the request-side wireless apparatus 10 corresponds to the connected request-side wireless apparatus 10 mentioned earlier. The request-side wireless apparatus 10 that is the source of the newly received connection request corresponds to the new request-side wireless apparatus 10 mentioned earlier. In this case, if the found information of the new request-side wireless apparatus 10 includes information regarding the plurality of pieces of admission-side wireless apparatus 12, the admitter 54 rejects connection of the new request-side wireless apparatus 10. In a case where neither the found information of the new request-side wireless apparatus 10 nor the found information of the connected request-side wireless apparatus 10 includes information regarding the plurality of pieces of admission-side wireless apparatus 12, the admitter 54 rejects connection of the new request-side wireless apparatus 10.

In case where the found information of the new request-side wireless apparatus 10 does not include information regarding the plurality of pieces of admission-side wireless apparatus 12 and the found information of the connected request-side wireless apparatus 10 includes information regarding the plurality of pieces of admission-side wireless apparatus 12, the admitter 54 disconnects the connected request-side wireless apparatus 10. At that time, the admitter 54 admits connection of the new request-side wireless apparatus 10. In other words, the admitter 54 selects the request-side wireless apparatus 10 based on the found information received at the reception unit, and preferentially selects the request-side wireless apparatus 10 that has found only one piece of admission-side wireless apparatus 12. In this manner, the admitter 54 admits connection for one of a plurality of pieces of request-side wireless apparatus 10 with respect to a connection request received at the reception unit 52.

In the case of maintaining connection of the connected request-side wireless apparatus 10 and rejecting connection of the new request-side wireless apparatus 10, the admitter 54 transmits a response that includes rejection of the connection to the new request-side wireless apparatus 10 via the near-field communicator 50. On the other hand, in the case of disconnecting the connected request-side wireless apparatus 10 and admitting connection of the new request-side wireless apparatus 10, the admitter 54 transmits, via the near-field communicator 50, an instruction of disconnection to the connected request-side wireless apparatus 10 and a response that includes admission of the connection to the new request-side wireless apparatus 10. An instruction of disconnection is transmitted in a similar manner to a rejection of connection. The admitter 54 outputs a result of processing to the processor 56.

As the result of the processing at the admitter 54, the processor 56 performs communication with the connected request-side wireless apparatus 10 using near-field communication via the near-field communicator 50. In addition, the processor 56 also performs communication using long-distance communication via the long-distance communicator 58. As a result, the processor 56 also performs relay between near-field communication and long-distance communication.

This processing will be explained based on FIG. 1. The second piece of request-side wireless apparatus 10b is connected to the first admission-side wireless apparatus 12a as the connected request-side wireless apparatus 10 mentioned earlier. At that time, the found information of the second piece of request-side wireless apparatus 10b includes information regarding the first admission-side wireless apparatus 12a and the second piece of admission-side wireless apparatus 12b. In other words, the found information includes information regarding the plurality of pieces of admission-side wireless apparatus 12. In this state, the first request-side wireless apparatus 10a requests connection with respect to the first admission-side wireless apparatus 12a. The first admission-side wireless apparatus 12a temporarily connects the first request-side wireless apparatus 10a and derives found information from the first request-side wireless apparatus 10a. The found information from the first request-side wireless apparatus 10a includes information regarding only the first admission-side wireless apparatus 12a. In other words, the found information does not include information regarding the plurality of pieces of admission-side wireless apparatus 12.

Thus, the first admission-side wireless apparatus 12a disconnects the second piece of request-side wireless apparatus 10b and connects the first request-side wireless apparatus 10a. The second piece of request-side wireless apparatus 10b removes information regarding the first admission-side wireless apparatus 12a from the found information and constructs new found information that includes only the second piece of admission-side wireless apparatus 12b. The second piece of request-side wireless apparatus 10b requests connection and transmits the new found information to the second piece of admission-side wireless apparatus 12b. As a result of this processing, the first request-side wireless apparatus 10a communicates with the first admission-side wireless apparatus 12a and the second piece of request-side wireless apparatus 10b communicates with the second piece of admission-side wireless apparatus 12b.

This configuration is realized with a CPU, a memory, and other LSI of a computer in terms of hardware and realized with a program loaded in a memory in terms of software and the like, and here a functional block that is realized through cooperation thereof is drawn. Therefore, it is understood by a person skilled in the art that the functional block of them can be realized in a variety of forms of hardware alone, software alone, or a combination thereof.

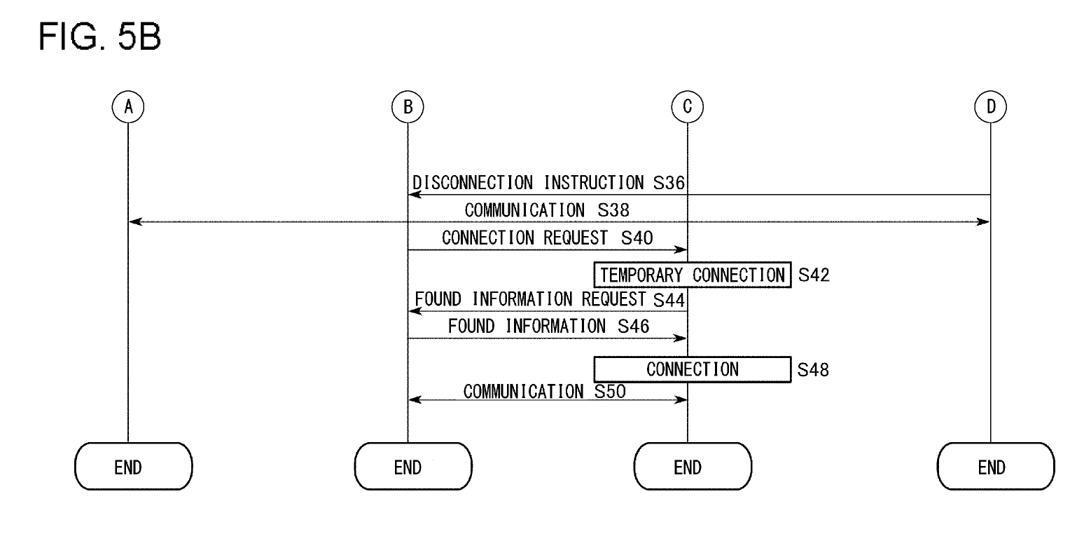

The operation of the communication system 100 with the above configuration will be described. FIGS. 5A and 5B are sequence diagrams that present a connection procedure by the communication system 100. The second piece of request-side wireless apparatus 10b performs search via near-field communication (S10). The second piece of request-side wireless apparatus 10b transmits a connection request to the first admission-side wireless apparatus 12a (S12). The first admission-side wireless apparatus 12a temporarily connects the second piece of request-side wireless apparatus 10b (S14). The first admission-side wireless apparatus 12a transmits a found information request to the second piece of request-side wireless apparatus 10b (S16). The second piece of request-side wireless apparatus 10b transmits a found information request to the first admission-side wireless apparatus 12a (S18). The first admission-side wireless apparatus 12a connects the second piece of request-side wireless apparatus 10b (S20). Upon transmitting a connection admission from the first admission-side wireless apparatus 12a, the second piece of request-side wireless apparatus 10b and the first admission-side wireless apparatus 12a perform communication (S22).

The first request-side wireless apparatus 10a performs search via near-field communication (S24). The first request-side wireless apparatus 10a transmits a connection request to the first admission-side wireless apparatus 12a (S26). The first admission-side wireless apparatus 12a temporarily connects the first request-side wireless apparatus 10a (S28). The first admission-side wireless apparatus 12a transmits a found information request to the first request-side wireless apparatus 10a (S30). The first request-side wireless apparatus 10a transmits a found information request to the first admission-side wireless apparatus 12a (S32). The first admission-side wireless apparatus 12a selects the first request-side wireless apparatus 10a (S34). The first admission-side wireless apparatus 12a transmits a disconnection instruction to the second piece of request-side wireless apparatus 10b (S36). Upon transmitting a connection admission from the first admission-side wireless apparatus 12a, the first request-side wireless apparatus 10a and the first admission-side wireless apparatus 12a perform communication (S38).

The second piece of request-side wireless apparatus 10b transmits a connection request to the second piece of admission-side wireless apparatus 12b (S40). The second piece of admission-side wireless apparatus 12b temporarily connects the second piece of request-side wireless apparatus 10b (S42). The second piece of admission-side wireless apparatus 12b transmits a found information request to the second piece of request-side wireless apparatus 10b (S44). The second piece of request-side wireless apparatus 10b transmits a found information request to the second piece of admission-side wireless apparatus 12b (S46). The second piece of admission-side wireless apparatus 12b connects the second piece of request-side wireless apparatus 10b (S48). Upon transmitting a connection admission from the second piece of admission-side wireless apparatus 12b, the second piece of request-side wireless apparatus 10b and the second piece of admission-side wireless apparatus 12b perform communication (S50).

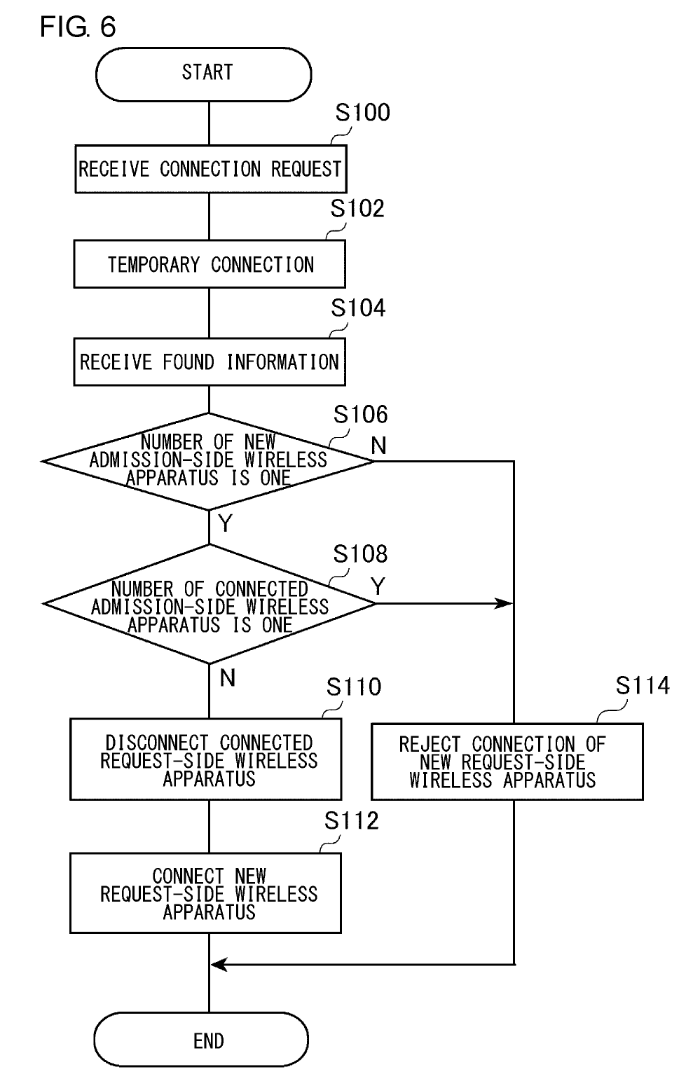

FIG. 6 is a flowchart that presents a connection procedure by the admission-side wireless apparatus 12. The reception unit 52 receives a connection request (S100) and establishes temporary connection (S102). The reception unit 52 receives found information (S104). In a case where the number of the piece of the admission-side wireless apparatus 12 found by the new request-side wireless apparatus 10 is one (Y at S106) and the number of the piece of the admission-side wireless apparatus 12 found by the connected request-side wireless apparatus 10 is not one (N at S108), the admitter 54 disconnects the connected request-side wireless apparatus 10 (S110). The admitter 54 connects the new request-side wireless apparatus 10 (S112). In a case where the number of the piece of the admission-side wireless apparatus 12 found by the new request-side wireless apparatus 10 is not one (N at S106) or the number of the piece of the admission-side wireless apparatus 12 found by the connected request-side wireless apparatus 10 is one (Y at S108), the admitter 54 rejects connection of the new request-side wireless apparatus 10 (S114).

According to the present embodiment, since found information regarding one or more pieces of admission-side wireless apparatus that have been found is transmitted to admission-side wireless apparatus that has requested connection, the admission-side wireless apparatus that has requested connection can be notified of one or more pieces of admission-side wireless apparatus that are capable of establishing connection. In addition, when rejection of connection is received, new found information in which information regarding the admission-side wireless apparatus for which connection has been rejected is removed from the found information is constructed, and hence the one or more pieces of admission-side wireless apparatus that are capable of establishing connection can be accurately specified. In addition, when rejection of connection is received, new found information in which information regarding the admission-side wireless apparatus for which connection has been rejected is removed from the found information is constructed, and hence the found information can be updated to latest information.

In addition, when a connection request is received from a plurality of pieces of request-side wireless apparatus, any piece of request-side wireless apparatus is selected based on found information, and hence request-side wireless apparatus to be connected can be selected in consideration of a situation of admission-side wireless apparatus capable of establishing connection in the request-side wireless apparatus. In addition, request-side wireless apparatus that has found only one piece of admission-side wireless apparatus alone is preferentially selected, and hence the number of combinations of the request-side wireless apparatus with the admission-side wireless apparatus can be increased. In addition, the number of combinations of the request-side wireless apparatus with the admission-side wireless apparatus can be increased, and hence wireless apparatus can be efficiently connected.

The present invention has been described based on an embodiment. This embodiment is an example and it is understood by a person skilled in the art that there can be many variations in combination of components and processes and such variations are also within the scope of the present invention.

In the present embodiment, the request-side wireless apparatus 10 transmits found information to the admission-side wireless apparatus 12 when the admission-side wireless apparatus 12 requests the request-side wireless apparatus 10 to transmit found information. However, the present embodiment is not limited thereto and, for example, the request-side wireless apparatus 10 may transmit a connection request that includes found information. According to the present variation, the number of times of transmission can be reduced.

What is claimed is:

1. A wireless apparatus on a side where connection is requested, comprising:
a searcher that searches another wireless apparatus on a side where connection is admitted;
a storage unit that stores found information regarding one or more pieces of other wireless apparatus that have been found as a result of search at the searcher; and
a requester that requests connection on one piece of another wireless apparatus in found information stored in the storage unit, wherein
the requester also transmits to the one piece of other wireless apparatus found information stored in the storage unit.

2. The wireless apparatus according to claim 1, further comprising:
a reception unit that receives rejection of connection from the one piece of another wireless apparatus for which connection is requested at the requester, wherein
in a case where the reception unit receives rejection of connection, the requester requests connection for another one piece of other wireless apparatus in found information stored in the storage unit, and
the requester also transmits to the another one piece of other wireless apparatus new found information in which information regarding the one piece of other wireless apparatus for which connection has been rejected at the reception unit is removed from found information stored in the storage unit.

3. A wireless apparatus on a side where connection is admitted, comprising:
a reception unit that receives a connection request from each of a plurality of pieces of other wireless apparatus on a side where connection is requested; and
an admitter that admits connection for one of a plurality of other wireless apparatus on a side where connection is requested with respect to a connection request received at the reception unit, wherein
the reception unit also receives found information that is from each of a plurality of pieces of other wireless apparatus on a side where connection is requested and that regards one or more pieces of wireless apparatus on a side where connection is admitted that have been found via search by other wireless apparatus on a side where connection is requested, and
the admitter performs selection based on found information received at the reception unit.

4. The wireless apparatus according to claim 3, wherein the admitter preferentially selects other wireless apparatus on a side where connection is requested that has found only one piece of wireless apparatus on a side where connection is admitted.

5. A communication system, comprising:
one or more pieces of request-side wireless apparatus on a side where connection is requested; and
one or more pieces of admission-side wireless apparatus on a side where connection is admitted, wherein
each of the one or more pieces of request-side wireless apparatus includes
a searcher that searches the one or more pieces of admission-side wireless apparatus,
a storage unit that stores found information regarding one or more pieces of admission-side wireless apparatus that have been found as a result of search at the searcher, and
a requester that requests connection for one piece of admission-side wireless apparatus in found information stored in the storage unit and also transmits found information stored in the storage unit to the one piece of admission-side wireless apparatus, and
each of the one or more pieces of admission-side wireless apparatus includes a reception unit that receives a connection request from request-side wireless apparatus and also receives found information and an admitter that admits connection for one piece of request-side wireless apparatus based on found information received at the reception unit with respect to a connection request received at the reception unit.
